(19) United States
(12) Patent Application Publication
(10) Pub. No.: US 2025/0047191 A1
(43) Pub. Date: Feb. 6, 2025

(54) MULTI-VOLTAGE POWER MANAGEMENT INTEGRATED CIRCUIT

(71) Applicant: Qorvo US, Inc., Greensboro, NC (US)

(72) Inventor: Nadim Khlat, Cugnaux (FR)

(21) Appl. No.: 18/754,467

(22) Filed: Jun. 26, 2024

Related U.S. Application Data
(60) Provisional application No. 63/592,714, filed on Oct. 24, 2023.
(60) Provisional application No. 63/517,386, filed on Aug. 3, 2023.

(51) Int. Cl. H02M 1/088; H02M 1/00; H02M 3/158

(52) U.S. Cl. CPC H02M 1/088; H02M 1/0025; H02M 3/158

(57) ABSTRACT

A multi-voltage power management integrated circuit (PMIC) is disclosed. More specifically, the multi-voltage PMIC is configured to generate multiple voltages by sharing a single voltage supply circuit. Herein, the multi-voltage PMIC includes multiple holding capacitors each holding a respective one of the voltages. According to embodiments disclosed herein, each of the holding capacitors is repeatedly discharged and recharged in each voltage generation cycle to maintain the respective one of the voltages at a desired level. As such, the multi-voltage PMIC can simultaneously supply the voltages based on the single voltage supply circuit, thus making it possible to support multiple load circuits (e.g., power amplifiers) with a smaller footprint.

### RELATED APPLICATIONS

This application claims the benefit of U.S. provisional patent application Ser. No. 63/517,386, filed on Aug. 3, 2023, and U.S. provisional patent application Ser. No. 63/592,714, filed on Oct. 24, 2023, the disclosures of which are hereby incorporated herein by reference in their entireties.

### FIELD OF THE DISCLOSURE

The present disclosure is related to a power management integrated circuit (PMIC) that is capable of simultaneously supplying multiple voltages at various levels.

### BACKGROUND

Mobile communication devices have become increasingly common in current society for providing wireless communication services. The prevalence of these mobile communication devices is driven in part by the many functions that are now enabled on such devices. Increased processing capabilities in such devices means that mobile communication devices have evolved from being pure communication tools into sophisticated mobile multimedia centers that enable enhanced user experiences.

The redefined user experience requires higher data rates offered by such advanced wireless communication technologies as fifth-generation new-radio (5G-NR). To achieve higher data rates, a mobile communication device may employ a power amplifier(s) to amplify a radio frequency (RF) signal(s) (e.g., maintaining sufficient energy per bit) before transmission. Given that the power amplifier(s) requires a supply voltage(s) for operation, a power management integrated circuit (PMIC) is thus required to generate and provide the supply voltage(s) to the power amplifier(s).

Given that the PMIC often needs to concurrently generate multiple supply voltages for multiple power amplifiers, the PMIC typically includes multiple direct-current to direct-current (DC-DC) converters for modulating the multiple supply voltages. Having multiple DC-DC converters will inevitably increase a footprint of the PMIC, thus making it difficult to fit the PMIC into an increasingly miniaturized electronic device(s) such as a smartphone and a smart gadget. Hence, it is desirable to reduce the number of DC-DC converters in the PMIC to help reduce the footprint of the PMIC.

### SUMMARY

Embodiments of the disclosure relate to a multi-voltage power management integrated circuit (PMIC). More specifically, the multi-voltage PMIC is configured to generate multiple voltages by sharing a single voltage supply circuit. Herein, the multi-voltage PMIC includes multiple holding capacitors each holding a respective one of the voltages. According to embodiments disclosed herein, each of the holding capacitors is repeatedly discharged and recharged in each voltage generation cycle to maintain the respective one of the voltages at a desired level. As such, the multi-voltage PMIC can simultaneously supply the voltages based on the single voltage supply circuit, thus making it possible to support multiple load circuits (e.g., power amplifiers) with a smaller footprint.

In one aspect, a multi-voltage PMIC is provided. The multi-voltage PMIC includes multiple holding capacitors. Each of the multiple holding capacitors is configured to provide a respective one of multiple voltages during a respective one of multiple voltage steps in each of multiple voltage generation cycles. The multi-voltage PMIC also includes a control circuit. The control circuit is configured to receive multiple voltage targets each indicating a respective level of the multiple voltages in a respective one of the multiple voltage generation cycles. The control circuit is also configured to assign each of the multiple holding capacitors to the respective one of the multiple voltage steps in accordance with the multiple voltage targets. The control circuit is also configured to cause each of the multiple holding capacitors to discharge during the respective one of the multiple voltage steps and recharge outside the respective one of the multiple voltage steps in each of the multiple voltage generation cycles.

In another aspect, a wireless device is provided. The wireless device includes a multi-voltage PMIC. The multi-voltage PMIC includes multiple holding capacitors. Each of the multiple holding capacitors is configured to provide a respective one of multiple voltages during a respective one of multiple voltage steps in each of multiple voltage generation cycles. The multi-voltage PMIC also includes a control circuit. The control circuit is configured to receive multiple voltage targets each indicating a respective level of the multiple voltages in a respective one of the multiple voltage generation cycles. The control circuit is also configured to assign each of the multiple holding capacitors to the respective one of the multiple voltage steps in accordance with the multiple voltage targets. The control circuit is also configured to cause each of the multiple holding capacitors to discharge during the respective one of the multiple voltage steps and recharge outside the respective one of the multiple voltage steps in each of the multiple voltage generation cycles.

In another aspect, a method for concurrently providing multiple voltages is provided. The method includes configuring multiple holding capacitors to each provide a respective one of multiple voltages during a respective one of multiple voltage steps in each of multiple voltage generation cycles. The method also includes receiving multiple voltage targets each indicating a respective level of the multiple voltages in a respective one of the multiple voltage generation cycles. The method also includes assigning each of the multiple holding capacitors to the respective one of the multiple voltage steps in accordance with the multiple voltage targets. The method also includes causing each of the multiple holding capacitors to discharge during the respective one of the multiple voltage steps and recharge outside the respective one of the multiple voltage steps in each of the multiple voltage generation cycles.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic diagram of an exemplary multi-voltage power management integrated circuit (PMIC) configured according to embodiments of the present disclosure to concurrently supply multiple voltages during a voltage generation cycle(s);

FIGS. 2A and 2B are schematic diagrams providing exemplary illustrations of the voltage generation cycle(s) in FIG. 1;

FIGS. 3A-3C are schematic diagrams illustrating exemplary operating scenarios of the multi-voltage PMIC of FIG. 1;

FIG. 4 is a schematic diagram of an exemplary communication device wherein the multi-voltage PMIC of FIG. 1 can be provided; and

FIG. 5 is a flowchart of an exemplary process whereby the multi-voltage PMIC of FIG. 1 can be configured to concurrently provide the multiple voltages during the voltage generation cycle(s).

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to a multi-voltage power management integrated circuit (PMIC). More specifically, the multi-voltage PMIC is configured to generate multiple voltages by sharing a single voltage supply circuit. Herein, the multi-voltage PMIC includes multiple holding capacitors each holding a respective one of the voltages. According to embodiments disclosed herein, each of the holding capacitors is repeatedly discharged and recharged in each voltage generation cycle to maintain the respective one of the voltages at a desired level. As such, the multi-voltage PMIC can simultaneously supply the voltages based on the single voltage supply circuit, thus making it possible to support multiple load circuits (e.g., power amplifiers) with a smaller footprint.

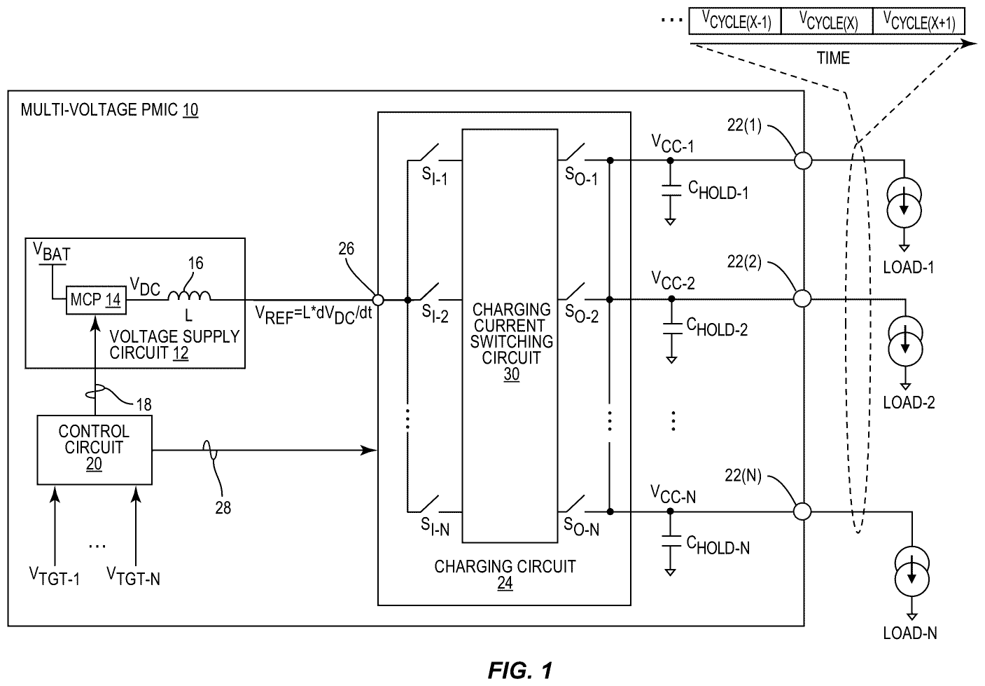

FIG. 1 is a schematic diagram of an exemplary multi-voltage PMIC 10 configured according to embodiments of the present disclosure to concurrently supply multiple voltages V_{CC-1}-V_{CC-N} during each of multiple voltage generation cycles V_{CYCLE(X-1)}, V_{CYCLE(X)}, V_{CYCLE(X+1)}. Herein, the voltage generation cycles V_{CYCLE(X-1)}, V_{CYCLE(X)}, V_{CYCLE(X+1)} represent any three consecutive voltage generation cycles among an infinite number of voltage generation cycles, which are omitted herein for simplicity.

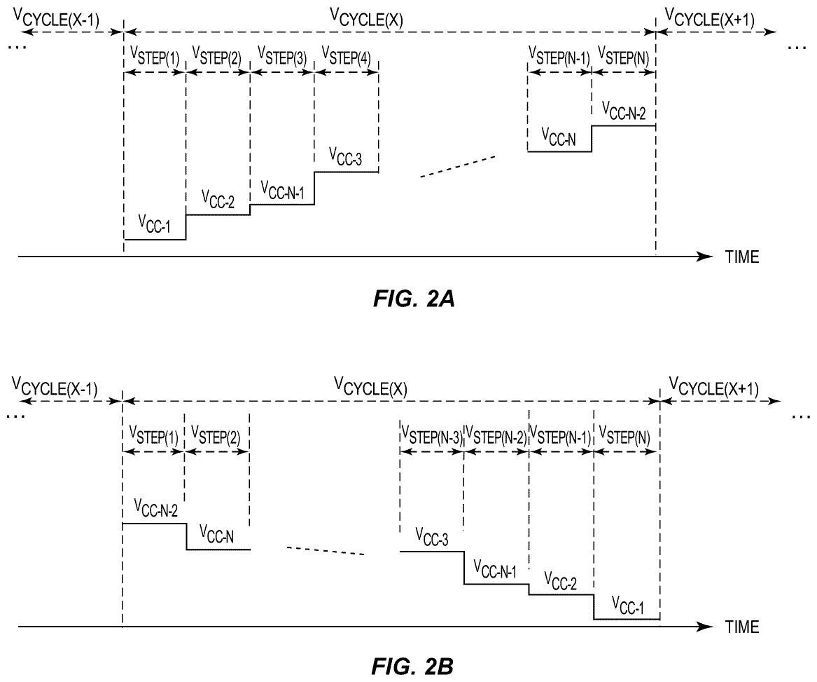

FIGS. 2A and 2B are schematic diagrams providing exemplary illustrations of the voltage generation cycles V_{CYCLE(X-1)}, V_{CYCLE(X)}, V_{CYCLE(X+1)} in FIG. 1. Common elements between FIGS. 1 and 2A-2B are shown therein with common element numbers and will not be re-described herein.

In an embodiment, each of the voltage generation cycles V_{CYCLE(X-1)}, V_{CYCLE(X)}, V_{CYCLE(X+1)} is further divided into multiple voltage steps V_{STEP(1)}-V_{STEP(N)}. Each of the voltage steps V_{STEP(1)}-V_{STEP(N)} is used to generate one of the voltages V_{CC-1}-V_{CC-N}. Notably, although a total number of the voltage steps V_{STEP(1)}-V_{STEP(N)} is identical to the total number of the voltages V_{CC-1}-V_{CC-N}, it is not necessary for the voltages V_{CC-1}-V_{CC-N} to be generated in the same order as the voltage steps V_{STEP(1)}-V_{STEP(N)}. Rather, the multi-voltage PMIC 10 can be configured to generate the voltages V_{CC-1}-V_{CC-N} monotonically to minimize a relative voltage change between each pair of the voltages V_{CC-1}-V_{CC-N}. In this regard, the voltages V_{CC-1}-V_{CC-N} as generated by the multi-voltage PMIC 10 can be out of order from the voltage steps V_{STEP(1)}-V_{STEP(N)}. Specifically, FIG. 2A illustrates that the voltages V_{CC-1}-V_{CC-N} are generated in an ascending order, and FIG. 2B illustrates that the voltages V_{CC-1}-V_{CC-N} are generated in a descending order.

In an embodiment, the multi-voltage PMIC 10 may be configured to generate the voltages V_{CC-1}-V_{CC-N} based on both the ascending and the descending orders. In one non-limiting example, the multi-voltage PMIC 10 may be configured to generate the voltages V_{CC-1}-V_{CC-N} in the ascending order in a preceding one of the voltage generation cycles V_{CYCLE(X-1)}, V_{CYCLE(X)}, V_{CYCLE(X+1)} (e.g., V_{CYCLE(X)}) and then generate the voltages V_{CC-1}-V_{CC-N} in the descending order in a succeeding one of the voltage generation cycles V_{CYCLE(X-1)}, V_{CYCLE(X)}, V_{CYCLE(X+1)} (e.g., V_{CYCLE(X+1)}). In another non-limiting example, the multi-voltage PMIC 10 may be configured to generate the voltages V_{CC-1}-V_{CC-N} in the descending order in a preceding one of the voltage generation cycles V_{CYCLE(X-1)}, V_{CYCLE(X)}, V_{CYCLE(X+1)} (e.g., V_{CYCLE(X)}) and then generate the voltages V_{CC-1}-V_{CC-N} in the ascending order in a succeeding one of the voltage generation cycles V_{CYCLE(X-1)}, V_{CYCLE(X)}, V_{CYCLE(X+1)} (e.g., V_{CYCLE(X+1)}).

With reference back to FIG. 1, the multi-voltage PMIC 10 includes a voltage supply circuit 12. The voltage supply circuit 12 includes a multi-level charge pump (MCP) 14 and a power inductor 16. Herein, the MCP 14 is configured to generate a low-frequency voltage V_{DC} as a function of a battery voltage V_{BAT}. The power inductor 16, which has an inductance L, is configured to modulate a reference voltage V_{REF} as a function of the low-frequency voltage V_{DC} (V_{REF}=L×dV_{DC}/dt).

In an embodiment, the MCP 14 is a direct-current-direct-current (DC-DC) buck-boost converter that can toggle between a buck mode and a boost mode in accordance with a duty cycle signal 18. When operating in the buck mode, the MCP 14 can generate the low-frequency voltage V_{DC} to equal a zero volt (0 V) or the battery voltage V_{BAT}. When operating in the boost mode, the MCP 14 can generate the low-frequency voltage V_{DC} at twice the battery voltage V_{BAT} (2×V_{BAT}). In this regard, by determining the duty cycle signal 18 to toggle the low-frequency voltage V_{DC} between 0 V, V_{BAT}, and/or 2×V_{BAT} in accordance with an appropriate ratio, it is possible to modulate the reference voltage V_{REF} at any desirable level.

The multi-voltage PMIC 10 also includes a control circuit 20, which can include a microprocessor, a digital signal processor, and/or a general-purpose processor, as an example. The control circuit 20 is configured to receive (e.g., from a transceiver circuit) multiple voltage targets V_{TGT-1}-V_{TGT-N} that indicates respective levels of the voltages V_{CC-1}-V_{CC-N} during any of the voltage generation cycles V_{CYCLE(X-1)}, V_{CYCLE(X)}, V_{CYCLE(X+1)}. In an embodiment, the control circuit 20 may order the voltages V_{CC-1}-V_{CC-N} in the ascending order (as shown in FIG. 2A) or in the descending order (as shown in FIG. 2B) based on the respective levels indicated by the voltage targets V_{TGT-1}-V_{TGT-N}. Thereafter, the control circuit 20 can sequentially assign each of the voltages V_{CC-1}-V_{CC-N} into a respective one of the voltage steps V_{STEP(1)}-V_{STEP(N)}.

Accordingly, the control circuit 20 can determine the duty cycle signal 18 to cause the voltage supply circuit 12 to modulate the reference voltage V_{REF} in each of the voltage steps V_{STEP(1)}-V_{STEP(N)}. In an embodiment, the control circuit 20 is configured to determine the duty cycle signal 18 to cause the voltage supply circuit 12 to generate the reference voltage V_{REF} that is equal to the respective one of the voltages V_{CC-1}-V_{CC-N} during each of the voltage steps V_{STEP(1)}-V_{STEP(N)}. According to the example shown in FIG. 2A, the control circuit 20 determines the duty cycle signal 18 to cause the voltage supply circuit 12 to generate the reference voltage V_{REF} to equal V_{CC-1}, V_{CC-2}, V_{CC-N-1}, V_{CC-3}, V_{CC-N}, V_{CC-N-2} during the voltage steps V_{STEP(1)}, V_{STEP(2)}, V_{STEP(3)}, V_{STEP(4)}, V_{STEP(N-1)}, V_{STEP(N)}, respectively.

The multi-voltage PMIC 10 also includes multiple holding capacitors C_{HOLD-1}-C_{HOLD-N}, each of which is coupled to a respective one of multiple voltage outputs 22(1)-22(N) to supply a respective one of the voltages V_{CC-1}-V_{CC-N} to a respective one of multiple load circuits Load-1-Load-N. In each of the voltage generation cycles V_{CYCLE(X-1)}, V_{CYCLE(X)}, V_{CYCLE(X+1)}, each of the holding capacitors C_{HOLD-1}-C_{HOLD-N} is either discharged to supply the respective level of the respective one of the voltages V_{CC-1}-V_{CC-N} or recharged to maintain the respective level of the respective one of the voltages V_{CC-1}-V_{CC-N}.

According to an embodiment of the present disclosure, during each of the voltage steps V_{STEP(1)}-V_{STEP(N)} in any of the voltage generation cycles V_{CYCLE(X-1)}, V_{CYCLE(X)}, V_{CYCLE(X+1)}, only one of the holding capacitors C_{HOLD-1}-C_{HOLD-N} is discharged to supply the respective one of the voltages V_{CC-1}-V_{CC-N}, while the rest of the holding capacitors C_{HOLD-1}-C_{HOLD-N} are concurrently recharged to maintain the respective ones of the voltages V_{CC-1}-V_{CC-N}. As such, the multi-voltage PMIC 10 can make all of the voltages V_{CC-1}-V_{CC-N} concurrently available to the load circuits Load-1-Load-N based exclusively on the voltage supply circuit 12, thus making it possible to reduce the footprint of the multi-voltage PMIC 10.

Moreover, since each of the holding capacitors C_{HOLD-1}-C_{HOLD-N} is recharged in all but one of the voltage steps V_{STEP(1)}-V_{STEP(N)} in each of the voltage generation cycles V_{CYCLE(X-1)}, V_{CYCLE(X)}, V_{CYCLE(X+1)}, each of the holding capacitors C_{HOLD-1}-C_{HOLD-N} can be recharged rather frequently to hold the respective level of the respective one of the voltages V_{CC-1}-V_{CC-N}. As such, it is possible to make the holding capacitors C_{HOLD-1}-C_{HOLD-N} smaller to help further reduce the footprint of the multi-voltage PMIC 10. Further, by making the holding capacitors C_{HOLD-1}-C_{HOLD-N} smaller, it is also possible to reduce charging time of the holding capacitors C_{HOLD-1}-C_{HOLD-N} to thereby support faster adaptation of the voltages V_{CC-1}-V_{CC-N}.

In an embodiment, the multi-voltage PMIC 10 further includes a charging circuit 24. The charging circuit 24 is coupled between a common node 26 and each of the holding capacitors C_{HOLD-1}-C_{HOLD-N}. The common node 26 is further coupled to the voltage supply circuit 12 to receive the reference voltage V_{REF} in each of the voltage steps V_{STEP(1)}-V_{STEP(N)} in each of the voltage generation cycles V_{CYCLE(X-1)}, V_{CYCLE(X)}, V_{CYCLE(X+1)}.

In an embodiment, the charging circuit 24 includes multiple input switches S_{I-1}-S_{I-N}, multiple output switches S_{O-1}-S_{O-N}, and a charging current switching circuit 30. Herein, each of the input switches S_{I-1}-S_{I-N} corresponds to a respective one of the output switches S_{O-1}-S_{O-N} and is coupled to the common node 26. Each of the output switches S_{O-1}-S_{O-N} is coupled to a respective one of the holding capacitors C_{HOLD-1}-C_{HOLD-N}. The charging current switching circuit 30 is coupled between the input switches S_{I-1}-S_{I-N} and the output switches S_{O-1}-S_{O-N}.

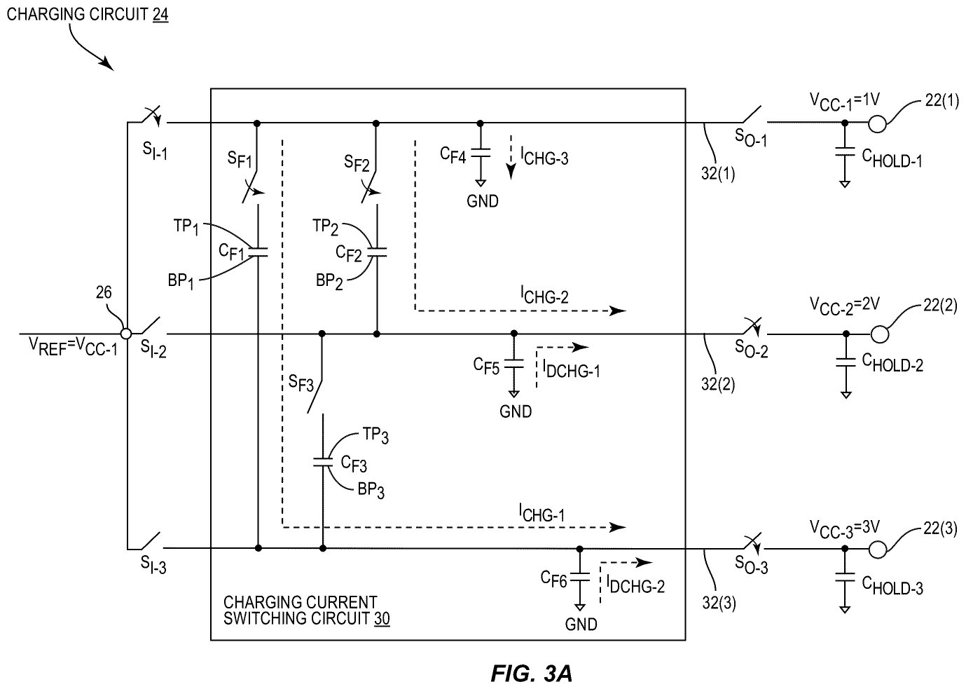

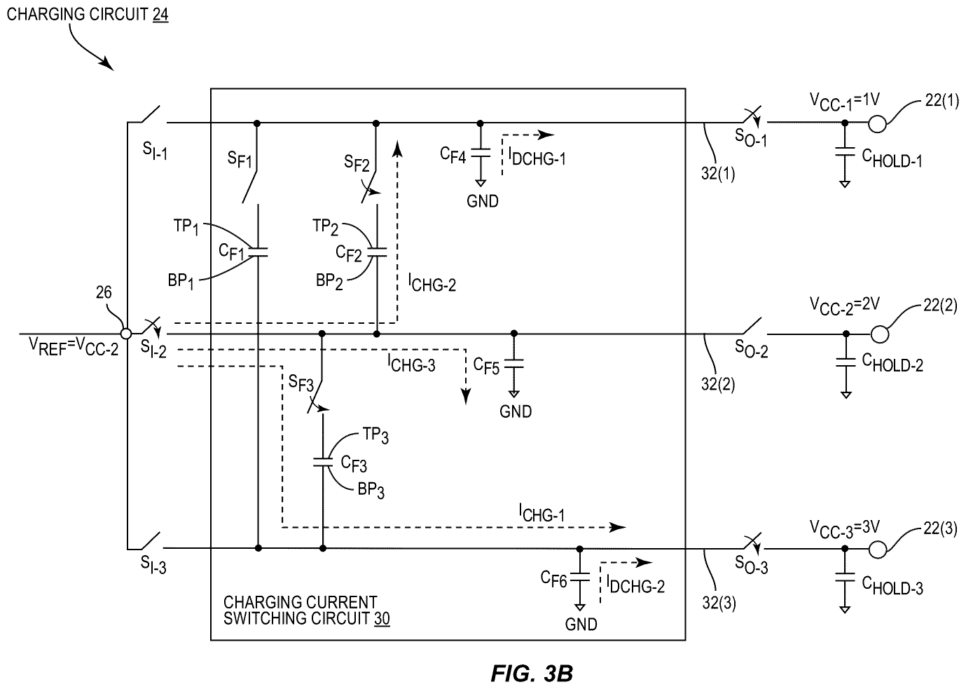

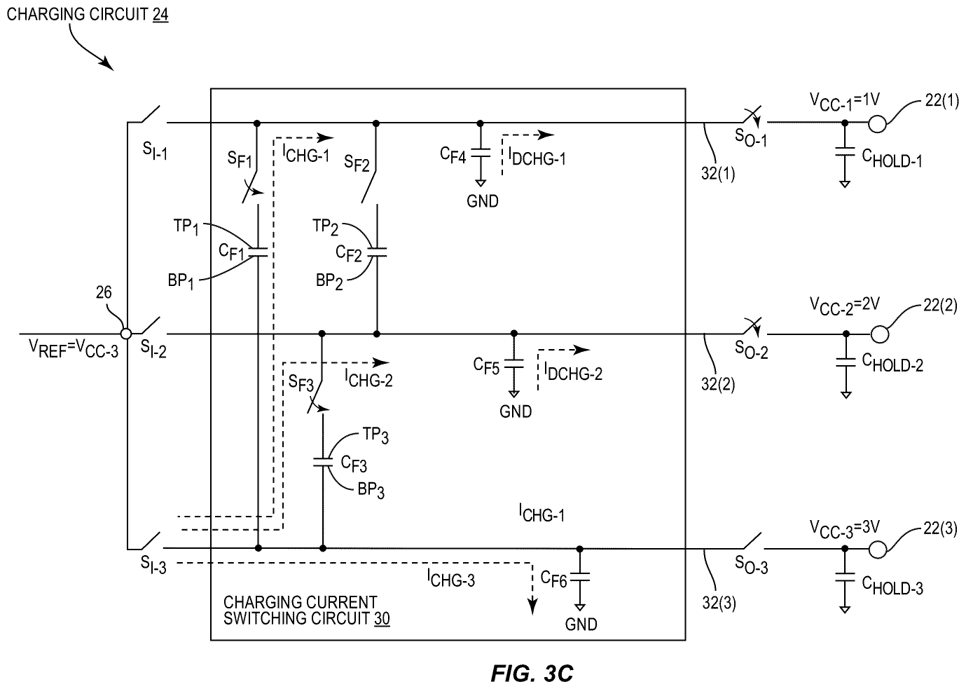

As described in a detailed example in FIGS. 3A-3C, each of the holding capacitors C_{HOLD-1}-C_{HOLD-N} will be discharged when the respective one of the input switches S_{I-1}-S_{I-N} is closed and the respective one of the output switches S_{O-1}-S_{O-N} is opened. In contrast, each of the holding capacitors C_{HOLD-1}-C_{HOLD-N} will be recharged when the respective one of the input switches S_{I-1}-S_{I-N} is opened and the respective one of the output switches S_{O-1}-S_{O-N} is closed. As an example, when the input switch S_{I-1} is closed and the output switch S_{O-1} is opened, the holding capacitor C_{HOLD-1} will be discharged to supply the voltage V_{CC-1}. In the meantime, if the rest of the input switches S_{I-2}-S_{I-N} are opened and the rest of the output switches S_{O-2}-S_{O-N} are closed, the rest of the holding capacitors C_{HOLD-2}-C_{HOLD-N} will be concurrently recharged to hold the respective voltages V_{CC-2}-V_{CC-N}.

Herein, the control circuit 20 can be configured to control the input switches S_{I-1}-S_{I-N} and the output switches S_{O-1}-S_{O-N} in the charging circuit 24 via a control signal 28. Specifically, during each of the voltage steps V_{STEP(1)}-V_{STEP(N)} in each of the voltage generation cycles V_{CYCLE(X-1)}, V_{CYCLE(X)}, V_{CYCLE(X+1)}, the control circuit 20 is configured to determine that the reference voltage V_{REF} at the common node 26 is set to be equal to one of the voltages V_{CC-1}-V_{CC-N}. Therefore, the control circuit 20 can determine which of the holding capacitors C_{HOLD-1}-C_{HOLD-N} is configured to supply the respective one of the voltages V_{CC-1}-V_{CC-N} that is equal to the reference voltage V_{REF}. Accordingly, the control circuit 20 can close a respective one of the input switches S_{I-1}-S_{I-N} and open a respective one of the output switches S_{O-1}-S_{O-N} to thereby cause the identified holding capacitor among the holding capacitors C_{HOLD-1}-C_{HOLD-N} to be discharged. Concurrently, the control circuit 20 can open all remaining ones of the input switches S_{I-1}-S_{I-N} and close all remaining ones of the output switches S_{O-1}-S_{O-N} to thereby recharge all remaining ones of the holding capacitors C_{HOLD-1}-C_{HOLD-N}.

FIGS. 3A-3C are schematic diagrams providing exemplary illustrations of an operating scenario of the charging circuit 24. Common elements between FIGS. 1 and 3A-3C are shown therein with common element numbers and will not be re-described herein. For the sake of simplicity, it is assumed that the multi-voltage PMIC 10 includes three holding capacitors C_{HOLD-1}, C_{HOLD-2}, C_{HOLD-3} among the holding capacitors C_{HOLD-2}-C_{HOLD-N} in FIG. 1 and is configured to simultaneously supply three voltages V_{CC-1}, V_{CC-2}, V_{CC-3}. Nevertheless, the operating principles described in these examples can be applicable to the multi-voltage PMIC 10 with any other number of holding capacitors and configured to supply any other number of voltages.

In a non-limiting example, it is assumed that the multi-voltage PMIC 10 is configured to simultaneously supply the voltages V_{CC-1}, V_{CC-2}, V_{CC-3} at 1 V, 2 V, 3 V, respectively. It is further assumed that each of the voltage generation cycles V_{CYCLE(X-1)}, V_{CYCLE(X)}, V_{CYCLE(X+1)} includes three voltage steps V_{STEP(1)}, V_{STEP(2)}, V_{STEP(3)} and the voltages V_{CC-1}, V_{CC-2}, V_{CC-3} are associated respectively with the voltage steps V_{STEP(1)}, V_{STEP(2)}, V_{STEP(3)} according to the ascending order shown in FIG. 2A.

FIG. 3A illustrates an operation of the charging circuit 24 during the voltage step V_{STEP(1)}. In an embodiment, the charging current switching circuit 30 includes multiple voltage rails 32(1)-32(3), each including a respective one of the input switches S_{I-1}-S_{I-3} and a respective one of the output switches S_{O-1}-S_{O-3}. More specifically, each of the voltage rails 32(1)-32(3) is configured to couple a respective one of the holding capacitors C_{HOLD-1}-C_{HOLD-3} to the common node 26 via the respective one of the input switches S_{I-1}-S_{I-3} and the respective one of the output switches S_{O-1}-S_{O-3}.

The charging current switching circuit 30 also includes multiple fly capacitors C_{F1}-C_{F6} and multiple fly switches S_{F1}-S_{F3}. The fly capacitor C_{F1} and fly switch S_{F1} are coupled in series between the voltage rail 32(1) and the voltage rail 32(3). Accordingly, a top plate T_{P1} and a bottom plate B_{P1} of the fly capacitor C_{F1} are coupled respectively to the voltage rail 32(1) and the voltage rail 32(3). The fly capacitor C_{F2} and the fly switch S_{F2} are coupled in series between the voltage rail 32(1) and the voltage rail 32(2). Accordingly, a top plate TP₂ and a bottom plate BP₂ of the fly capacitor C_{F2} are coupled respectively to the voltage rail 32(1) and the voltage rail 32(2). The fly capacitor C_{F3} and the fly switch S_{F3} are coupled in series between the voltage rail 32(2) and the voltage rail 32(3). Accordingly, a top plate TP₃ and a bottom plate BP₃ of the fly capacitor C_{F3} are coupled respectively to the voltage rail 32(2) and the voltage rail 32(3). The fly capacitors C_{F4}, C_{F5}, C_{F6}, on the other hand, are coupled respectively between the voltage rails 32(1)-32(3) and a ground (GND).

During the voltage step V_{STEP(1)}, the reference voltage V_{REF} at the common node 26 is set to the voltage V_{CC-1}. Accordingly, the control circuit 20 can determine to discharge the holding capacitor C_{HOLD-1} and concurrently recharge the holding capacitors C_{HOLD-2} and C_{HOLD-3}. Specifically, the control circuit 20 closes the input switch S_{I-1} and the output switches S_{O-2}, S_{O-3}. Concurrently, the control circuit 20 opens the output switch S_{O-1} and the input switches S₁₋₂, S₁₋₃. As a result of opening the output switch S_{O-1}, the holding capacitor C_{HOLD-1} will be discharged to provide the voltage V_{CC-1} at the voltage output 22(1).

In addition, the control circuit 20 closes the fly switches S_{F1}, S_{F2} and keeps the fly switch S_{F3} open. As a result, a first charging current I_{CHG-1} will flow through the fly capacitor C_{F1} and the holding capacitor C_{HOLD-3} such that the bottom plate B_{P1} will have a respective voltage potential set by the voltage V_{CC-3}, thus helping to maintain the voltage V_{CC-3} at the voltage output 22(3).

Similarly, a second charging current I_{CHG2} will flow through the fly capacitor C_{F2} and the holding capacitor C_{HOLD-2} such that the bottom plate BP₂ will have a respective voltage potential set by the voltage V_{CC-2}, thus helping to maintain the voltage V_{CC-2} at the voltage output 22(2).

In the meantime, a third charging current I_{CHG-3} will charge the fly capacitor C_{F4} to the reference voltage V_{REF}. Concurrently, the fly capacitors C_{F5} and C_{F6} are each discharged to provide a respective discharging current I_{DCHG-1} and I_{DCHG-2} to help charge the holding capacitors C_{HOLD-2} and C_{HOLD-3} to help maintain the respective voltages V_{CC-2} and V_{CC-3} at the respective voltage outputs 22(2) and 22(3).

FIG. 3B illustrates an operation of the charging circuit 24 during the voltage step V_{STEP(2)}, during which the reference voltage V_{REF} at the common node 26 is set to the voltage V_{CC-2}. Accordingly, the control circuit 20 can determine to discharge the holding capacitor C_{HOLD-2} and concurrently recharge the holding capacitors C_{HOLD-1} and C_{HOLD-3}. Specifically, the control circuit 20 closes the input switch S_{I-2} and the output switches S_{O-1}, S_{O-3}. Concurrently, the control circuit 20 opens the output switch S_{O-2} and the input switches S_{I-1}, S_{I-3}. As a result of opening the output switch S_{O-2}, the holding capacitor C_{HOLD-2} will be discharged to provide the voltage V_{CC-2} at the voltage output 22(2).

In addition, the control circuit 20 closes the fly switches S_{F2}, S_{F3} and keeps the fly switch S_{F1} open. As a result, a first charging current I_{CHG-1} will flow through the fly capacitor C_{F3} and the holding capacitor C_{HOLD-3} such that the bottom plate BP₃ will have a respective voltage potential set by the voltage V_{CC-3}, thus helping to maintain the voltage V_{CC-3} at the voltage output 22(3).

Similarly, a second charging current I_{CHG-2} will flow through the fly capacitor C_{F2} and the holding capacitor C_{HOLD-1} such that the top plate TP₂ will have a respective voltage potential set by the voltage V_{CC-1}, thus helping to maintain the voltage V_{CC-1} at the voltage output 22(1).

In the meantime, a third charging current I_{CHG-3} will charge the fly capacitor C_{F5} to the reference voltage V_{REF}. Concurrently, the fly capacitors C_{F4} and C_{F6} are each discharged to provide a respective discharging current I_{DCHG-1} and I_{DCHG-2} to help charge the holding capacitors C_{HOLD-1} and C_{HOLD-3} to help maintain the respective voltages V_{CC-1} and V_{CC-3} at the respective voltage outputs 22(1) and 22(3).

FIG. 3C illustrates an operation of the charging circuit 24 during the voltage step V_{STEP(3)}, during which the reference voltage V_{REF} at the common node 26 is set to the voltage V_{CC-3}. Accordingly, the control circuit 20 can determine to discharge the holding capacitor C_{HOLD-3} and concurrently recharge the holding capacitors C_{HOLD-1} and C_{HOLD-2}. Specifically, the control circuit 20 closes the input switch S_{I-3} and the output switches S_{O-1}, S_{O-2}. Concurrently, the control circuit 20 opens the output switch S_{O-3} and the input switches S_{I-1}, S_{I-2}. As a result of opening the output switch S_{O-3}, the holding capacitor C_{HOLD-3} will be discharged to provide the voltage V_{CC-3} at the voltage output 22(3).

In addition, the control circuit 20 closes the fly switches S_{F1}, S_{F3} and keeps the fly switch S_{F2} open. As a result, a first charging current I_{CHG-1} will flow through the fly capacitor C_{F1} and the holding capacitor C_{HOLD-1} such that the top plate T_{P1} will have a respective voltage potential set by the voltage V_{CC-1}, thus helping to maintain the voltage V_{CC-1} at the voltage output 22(1).

Similarly, a second charging current I_{CHG-2} will flow through the fly capacitor C_{F3} and the holding capacitor C_{HOLD-2} such that the top plate TP₃ will have a respective voltage potential set by the voltage V_{CC-2}, thus helping to maintain the voltage V_{CC-2} at the voltage output 22(2).

In the meantime, a third charging current I_{CHG-3} will charge the fly capacitor C_{F6} to the reference voltage V_{REF}. Concurrently, the fly capacitors C_{F4} and C_{F5} are each discharged to provide a respective discharging current I_{DCHG-1} and I_{DCHG-2} to help charge the holding capacitors C_{HOLD-1} and C_{HOLD-2} to help maintain the respective voltages V_{CC-1} and V_{CC-2} at the respective voltage outputs 22(1) and 22(2).

With reference back to FIG. 1, in one embodiment, the multi-voltage PMIC 10 can be configured to simultaneously supply the voltages V_{CC-1}-V_{CC-4} (N=4) to support a four-by-four multiple-input multiple-output (4×4 MIMO) transmission. In another embodiment, the multi-voltage PMIC 10 can be configured to simultaneously supply the voltages V_{CC-1}-V_{CC-8} (N=8) to support an eight-by-eight multiple-input multiple-output (8×8 MIMO) transmission.

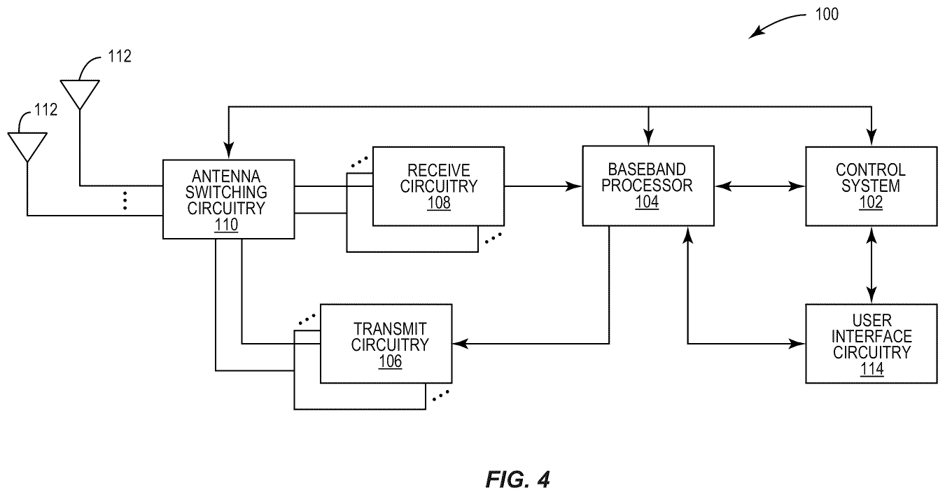

The multi-voltage PMIC 10 of FIG. 1 can be provided in a communication device to support the embodiments described above. In this regard, FIG. 4 is a schematic diagram of an exemplary communication device 100 wherein the multi-voltage PMIC 10 of FIG. 1 can be provided.

Herein, the communication device 100 can be any type of communication device, such as mobile terminals, smart watches, tablets, computers, navigation devices, access points, base stations (e.g., eNB, gNB), and like wireless communication devices that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application-specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal, and a modulator modulates the analog signal onto a carrier signal that is at a desired transmit frequency or frequencies. A power amplifier will amplify the modulated carrier signal to a level appropriate for transmission and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

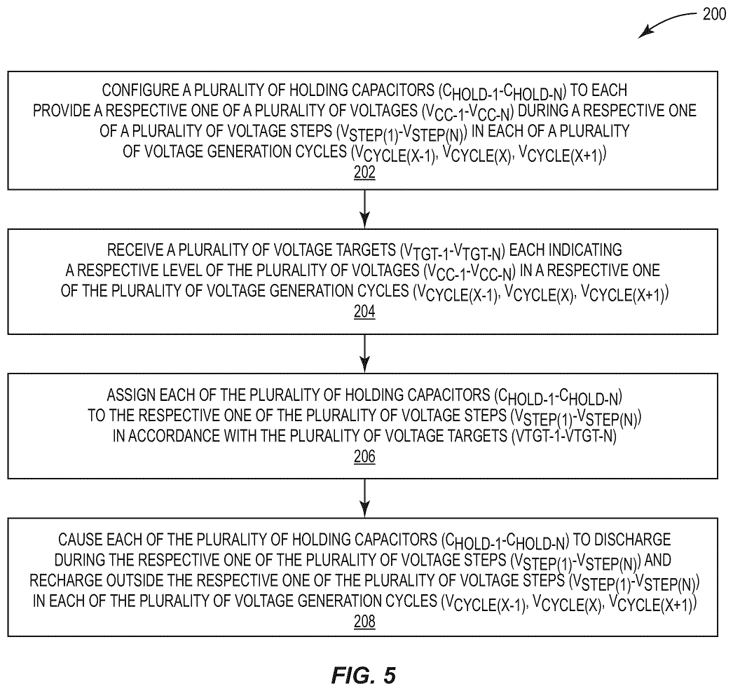

In an embodiment, it is possible to configure the multi-voltage PMIC of FIG. 1 to concurrently provide the voltages V_{CC-1}-V_{CC-N} in accordance with a process. In this regard, FIG. 5 is a flowchart of an exemplary process 200 whereby the multi-voltage PMIC 10 of FIG. 1 can be configured to concurrently provide the voltages V_{CC-1}-V_{CC-N}.

Herein, the process 200 includes configuring the holding capacitors C_{HOLD-1}-C_{HOLD-N} to each provide the respective one of the voltages V_{CC-1}-V_{CC-N} during the respective one of the steps V_{STEP(1)}-V_{STEP(N)} in each of the voltage generation cycles V_{CYCLE(X-1)}, V_{CYCLE(X)}, V_{CYCLE(X+1)} (step 202). The process 200 also includes receiving the voltage targets V_{TGT-1}-V_{TGT-N}, each indicating the respective level of the voltages V_{CC-1}-V_{CC-N} in the respective one of the voltage generation cycles V_{CYCLE(X-1)}, V_{CYCLE(X)}, V_{CYCLE(X+1)} (step 204). The process 200 also includes assigning each of the holding capacitors C_{HOLD-1}-C_{HOLD-N} to the respective one of the voltage steps V_{STEP(1)}-V_{STEP(N)} in accordance with the voltage targets V_{TGT-1}-V_{TGT-N}(step 206). The process 200 also includes causing each of the holding capacitors C_{HOLD-1}-C_{HOLD-N} to discharge during the respective one of the voltage steps V_{STEP(1)}-V_{STEP(N)} and recharge outside the respective one of the voltage steps V_{STEP(1)}-V_{STEP(N)} in each of the voltage generation cycles V_{CYCLE(X-1)}, V_{CYCLE(X)}, V_{CYCLE(X+1)} (step 208).

Those skilled in the art will recognize improvements and modifications to the preferred embodiments of the present disclosure. All such improvements and modifications are considered within the scope of the concepts disclosed herein and the claims that follow.

What is claimed is:

1. A multi-voltage power management integrated circuit (PMIC) comprising:
a plurality of holding capacitors, each configured to provide a respective one of a plurality of voltages during a respective one of a plurality of voltage steps in each of a plurality of voltage generation cycles; and
a control circuit configured to:
receive a plurality of voltage targets, each indicating a respective level of the plurality of voltages in a respective one of the plurality of voltage generation cycles;
assign each of the plurality of holding capacitors to the respective one of the plurality of voltage steps in accordance with the plurality of voltage targets; and
cause each of the plurality of holding capacitors to discharge during the respective one of the plurality of voltage steps and recharge outside the respective one of the plurality of voltage steps in each of the plurality of voltage generation cycles.

2. The multi-voltage PMIC of claim 1, wherein the control circuit is further configured to cause the plurality of holding capacitors to concurrently provide the plurality of voltages in each of the plurality of voltage generation cycles.

3. The multi-voltage PMIC of claim 1, wherein the plurality of voltages is generated monotonically in the plurality of voltage steps.

4. The multi-voltage PMIC of claim 1, wherein the control circuit is further configured to assign each of the plurality of holding capacitors to the respective one of the plurality of voltage steps in accordance with one of: a sequential order and a non-sequential order.

5. The multi-voltage PMIC of claim 1, wherein the control circuit is further configured to assign each of the plurality of holding capacitors to the respective one of the plurality of voltage steps in accordance with one of: an ascending order and a descending order.

6. The multi-voltage PMIC of claim 1, further comprising a charging circuit coupled between a common node and the plurality of holding capacitors, wherein the control circuit is further configured to:
receive a reference voltage at the common node in each of the plurality of voltage steps that indicates the respective level of the plurality of voltages; and
control the charging circuit to thereby cause each of the plurality of holding capacitors to discharge during the respective one of the plurality of voltage steps and recharge outside the respective one of the plurality of voltage steps in each of the plurality of voltage generation cycles.

7. The multi-voltage PMIC of claim 6, further comprising a voltage supply circuit coupled to the common node, wherein the control circuit is further configured to determine a duty cycle signal for each of the plurality of voltage steps to thereby cause the voltage supply circuit to generate the reference voltage at the common node in each of the plurality of voltage steps.

8. The multi-voltage PMIC of claim 7, wherein the charging circuit comprises:
a plurality of input switches, each corresponding to a respective one of the plurality of holding capacitors and coupled to the common node;
a plurality of output switches, each coupled to a respective one of the plurality of holding capacitors; and
a charging current switching circuit provided in between the plurality of input switches and the plurality of output switches.

9. The multi-voltage PMIC of claim 8, wherein the control circuit is further configured to:
open a respective one of the plurality of output switches coupled to the respective one of the plurality of holding capacitors to thereby cause the respective one of the plurality of holding capacitors to discharge;
close a respective one of the plurality of input switches corresponding to the respective one of the plurality of output switches;
open all remaining ones of the plurality of input switches; and
close all remaining ones of the plurality of output switches.

10. The multi-voltage PMIC of claim 8, wherein the plurality of holding capacitors comprises four holding capacitors configured to simultaneously supply four voltages, respectively, to support a four-by-four multiple-input multiple-output (4×4 MIMO) transmission.

11. The multi-voltage PMIC of claim 8, wherein the plurality of holding capacitors comprises eight holding capacitors configured to simultaneously supply eight voltages, respectively, to support an eight-by-eight multiple-input multiple-output (8×8 MIMO) transmission.

12. A wireless device comprising a multi-voltage power management integrated circuit (PMIC), the multi-voltage PMIC comprises:
a plurality of holding capacitors, each configured to provide a respective one of a plurality of voltages during a respective one of a plurality of voltage steps in each of a plurality of voltage generation cycles; and
a control circuit configured to:
receive a plurality of voltage targets, each indicating a respective level of the plurality of voltages in a respective one of the plurality of voltage generation cycles;
assign each of the plurality of holding capacitors to the respective one of the plurality of voltage steps in accordance with the plurality of voltage targets; and
cause each of the plurality of holding capacitors to discharge during the respective one of the plurality of voltage steps and recharge outside the respective one of the plurality of voltage steps in each of the plurality of voltage generation cycles.

13. The wireless device of claim 12, wherein the control circuit is further configured to cause the plurality of holding capacitors to concurrently provide the plurality of voltages in each of the plurality of voltage generation cycles.

14. The wireless device of claim 12, wherein the control circuit is further configured to assign each of the plurality of holding capacitors to the respective one of the plurality of voltage steps in accordance with one of: a sequential order and a non-sequential order.

15. The wireless device of claim 12, wherein the control circuit is further configured to assign each of the plurality of holding capacitors to the respective one of the plurality of voltage steps in accordance with one of: an ascending order and a descending order.

16. The wireless device of claim 12, wherein the multi-voltage PMIC further comprises a charging circuit coupled between a common node and the plurality of holding capacitors, wherein the control circuit is further configured to:
receive a reference voltage at the common node in each of the plurality of voltage steps that indicates the respective level of the plurality of voltages; and
control the charging circuit to thereby cause each of the plurality of holding capacitors to discharge during the respective one of the plurality of voltage steps and recharge outside the respective one of the plurality of voltage steps in each of the plurality of voltage generation cycles.

17. The wireless device of claim 16, wherein the multi-voltage PMIC further comprises a voltage supply circuit coupled to the common node, wherein the control circuit is further configured to determine a duty cycle signal for each of the plurality of voltage steps to thereby cause the voltage supply circuit to generate the reference voltage at the common node in each of the plurality of voltage steps.

18. The wireless device of claim 17, wherein the charging circuit comprises:
a plurality of input switches, each corresponding to a respective one of the plurality of holding capacitors and coupled to the common node;
a plurality of output switches, each coupled to a respective one of the plurality of holding capacitors; and
a charging current switching circuit provided in between the plurality of input switches and the plurality of output switches.

19. The wireless device of claim 18, wherein the control circuit is further configured to:
open a respective one of the plurality of output switches coupled to the respective one of the plurality of holding capacitors to thereby cause the respective one of the plurality of holding capacitors to discharge;
close a respective one of the plurality of input switches corresponding to the respective one of the plurality of output switches;
open all remaining ones of the plurality of input switches; and
close all remaining ones of the plurality of output switches.

20. A method for concurrently providing multiple voltages comprising:
configuring a plurality of holding capacitors to each provide a respective one of a plurality of voltages during a respective one of a plurality of voltage steps in each of a plurality of voltage generation cycles;
receiving a plurality of voltage targets, each indicating a respective level of the plurality of voltages in a respective one of the plurality of voltage generation cycles;
assigning each of the plurality of holding capacitors to the respective one of the plurality of voltage steps in accordance with the plurality of voltage targets; and
causing each of the plurality of holding capacitors to discharge during the respective one of the plurality of voltage steps and recharge outside the respective one of the plurality of voltage steps in each of the plurality of voltage generation cycles.
